(19) United States
(12) Patent Application Publication
(10) Pub. No.: US 2012/0240850 A1
(43) Pub. Date: Sep. 27, 2012

(54) Deposition mask

(76) Inventors: Ikunori Kobayashi, Yongin-City (KR); Jung Woo Ko, Yongin-city (KR); Sang Shin Lee, Yongin-city (KR); Taek Kyo Kang, Yongin-city (KR)

(21) Appl. No.: 13/137,913

(22) Filed: Sep. 21, 2011

(30) Foreign Application Priority Data
Mar. 24, 2011 (KR) 10-2011-0026424

(51) Int. Cl. B05C 11/00

(52) U.S. Cl. 118/504

(57) ABSTRACT

A deposition mask that is placed on a mask frame by a tensile force includes first through n^{th} corrected patterns obtained by correcting first through n^{th} initially designed patterns, which are arranged sequentially in a first direction, a row direction and a column direction in view of the tensile force applied to the deposition mask. Outermost sides of the first through n^{th} corrected patterns include first outermost sides extending in a second direction perpendicular to the first direction and second outermost sides extending in a direction parallel to the first direction. The first outermost sides have a first curvature and are recessed inwardly with respect to the first and the n^{th} initially designed patterns. The second outermost sides have a second curvature and protrude outwardly with respect to the first through n^{th} initially designed patterns.

### CROSS REFERENCE TO RELATED APPLICATION

Korean Patent Application No. 10-2011-0026424 was filed on Mar. 24, 2011 in the Korean Intellectual Property Office, the disclosure of which is incorporated herein by reference in its entirety.

### BACKGROUND OF THE INVENTION

1. Field of the Invention

The present invention relates to a deposition mask, and more particularly, to a deposition mask whose pattern precision can be maintained even when a tensile force is applied thereto.

2. Description of the Related Art

Electroluminescent devices, which are self-luminous display devices, are drawing attention as next-generation display devices due to their wide viewing angle, high contrast, and high response speed.

These electroluminescent devices are divided into inorganic electroluminescent devices and organic electroluminescent devices according to the material that forms a light-emitting layer. Organic electroluminescent devices have higher luminance and response speed than those of inorganic electroluminescent devices and are capable of displaying color images. Due to these advantages, organic electroluminescent devices are being actively developed.

### SUMMARY OF THE INVENTION

According to an embodiment, there is provided a deposition mask placed on a mask frame by a tensile force, the deposition mask including first through n^{th} corrected patterns obtained by correcting first through n^{th} initially designed patterns, that include a first initially designed pattern and an n^{th} initially designed pattern, the first through n^{th} initially designed patterns being arranged sequentially in a first direction, in a row direction and a column direction in view of the tensile force applied to the deposition mask, wherein outermost sides of the first through n^{th} corrected patterns include first outermost sides extending in a second direction perpendicular to the first direction and second outermost sides extending in a direction parallel to the first direction, wherein the first outermost sides have a first curvature and are recessed inwardly with respect to the first and the n^{th} initially designed patterns, and the second outermost sides have a second curvature and protrude outwardly with respect to the first through n^{th} initially designed patterns.

The first curvature may be determined by first and second points at opposite ends of a first side of each of the first and the n^{th} initially designed patterns which corresponds to each of the first outermost sides and a third point separated from a first midpoint of the first side by a first distance in a direction opposite to a direction in which the tensile force is applied.

The second curvature may be determined by fourth and fifth points at opposite ends of a second side of each of the first through n^{th} initially designed patterns which corresponds to each of the second outermost sides and a sixth point separated from a second midpoint of the second side by a second distance in a direction perpendicular to the direction in which the tensile force is applied.

Each of the first through n^{th} corrected patterns may include a plurality of slit lines.

The slit lines may be arranged in each of the first through n^{th} corrected patterns in view of the tensile force.

The deposition mask may further include first through n^{th} device patterns placed on the mask frame by the tensile force, wherein each of the first through n^{th} device patterns has a first length defined by the first direction and a first width defined by the second direction, and the first through n^{th} initially designed patterns correspond respectively to the first through n^{th} device patterns and have a second length defined by the first direction and a second width defined by the second direction, wherein the second length is smaller than the first length, and the second width is greater than the first width.

A ratio of the second length to the first length and a ratio of the second width relative to the first width may be determined by a magnitude of the tensile force.

The first through n^{th} corrected patterns may include a second corrected pattern and an (n−1)^{th} corrected pattern, and each of the first through n^{th} corrected patterns and each of the first through n^{th} initially designed patterns may include at least four sides, wherein the first corrected pattern includes a first side included in the first outermost sides, second and third sides included in the second outermost sides and a fourth side facing the second corrected pattern, the n^{th} corrected pattern includes a first side included in the first outermost sides, second and third sides included in the second outermost sides and a fourth side facing the (n−1)^{th} corrected pattern, and each of the second through (n−1)^{th} corrected patterns includes second and third sides included in the second outermost sides, a first side facing a previous corrected pattern and a fourth side facing a next corrected pattern.

The first sides of the first corrected pattern and the n^{th} corrected pattern may be recessed inwardly with respect to the first and the n^{th} initially designed patterns, and the second and third sides of the first through n^{th} corrected patterns may protrude outwardly with respect to the first through n^{th} initially designed patterns.

Each of the first through n^{th} initially designed patterns may correspond to any one of a plurality of display panels placed on the mask frame.

Each of the first through n^{th} initially designed patterns may include a plurality of apertures.

According to another embodiment, there is provided a deposition mask placed on a mask frame by a tensile force, the deposition mask comprising first through n^{th} corrected patterns which correspond respectively to a plurality of display panels arranged in a row along a first direction parallel to a direction of the tensile force applied to the deposition mask, wherein outermost sides of the first through n^{th} corrected patterns include first outermost sides extending in a second direction perpendicular to the first direction and second outermost sides extending in a direction parallel to the first direction, wherein the first outermost sides have a first curvature and are recessed inwardly with respect to first and the n^{th} initially designed patterns, and the second outermost sides have a second curvature and protrude outwardly with respect to first through n^{th} initially designed patterns.

The deposition mask may further include first through n^{th} device patterns placed on the mask frame by the tensile force and the first through n^{th} initially designed patterns corresponding respectively to the first through n^{th} device patterns, wherein each of the first through n^{th} device patterns has a first length defined by the first direction, and each of the first through n^{th} initially designed patterns has a second length defined by the first direction, wherein the second length is smaller than the first length.

Each of the first through n^{th} initially designed patterns may have a first width defined by the second direction perpendicular to the first direction, and each of the first through n^{th} corrected patterns has a second width defined by the second direction, wherein the second width is greater than the first width.

The first curvature may be determined by first and second points at opposite ends of a first side of each of the first and the n^{th} initially designed patterns which corresponds to each of the first outermost sides and a third point separated from a first midpoint of the first side by a first distance in a direction opposite to the direction in which the tensile force is applied.

The second curvature may be determined by fourth and fifth points at opposite ends of a second side of each of the first through n^{th} initially designed patterns which corresponds to each of the second outermost sides and a sixth point separated from a second midpoint of the second side by a second distance in a direction perpendicular to the direction in which the tensile force is applied.

### BRIEF DESCRIPTION OF THE DRAWINGS

The above and other aspects and features of the present invention will become more apparent by describing in detail exemplary embodiments thereof with reference to the attached drawings, in which:

FIG. 1 is a perspective view of a deposition mask according to an exemplary embodiment of the present invention;

FIG. 2 is a plan view of the deposition mask shown in FIG. 1;

FIGS. 3A through 3C are conceptual views for explaining a method of obtaining corrected patterns from initially designed patterns shown in FIG. 2;

FIG. 3D illustrates slit lines formed in a corrected pattern;

FIG. 4 is a perspective view of a deposition mask according to another exemplary embodiment of the present invention; and

FIG. 5 is a cross-sectional view of the deposition mask shown in FIG. 4.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. In the drawings, sizes and relative sizes of elements may be exaggerated for clarity. Like reference numerals refer to like elements throughout the specification. As used herein, the term “and/or” includes any and all combinations of one or more of the associated listed items.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises” and/or “made of,” when used in this specification, specify the presence of stated components, steps, operations, and/or elements, but do not preclude the presence or addition of one or more other components, steps, operations, elements, and/or groups thereof.

It will be understood that, although the terms first, second, third, etc., may be used herein to describe various elements, these elements should not be limited by these terms. These terms are only used to distinguish one element from another element. Thus, a first element discussed below could be termed a second element without departing from the teachings of the present invention

Embodiments of the invention are described herein with reference to plan and cross-section illustrations that are schematic illustrations of idealized embodiments of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. With respect to a corrected pattern and/or an initially designed pattern as discussed in more detail below, the terms “inwardly” and “outwardly” may refer respectively to directions toward or away from a center of the pattern in a plane of the deposition mask.

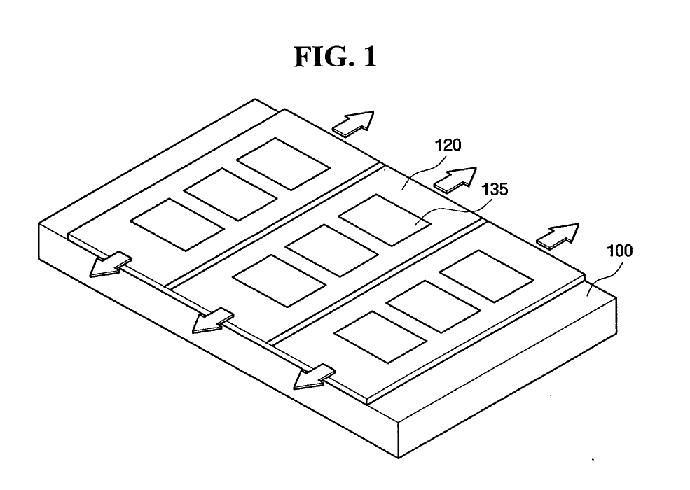

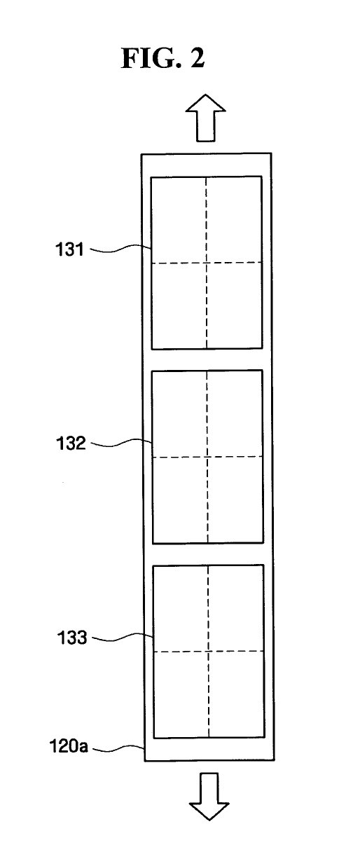

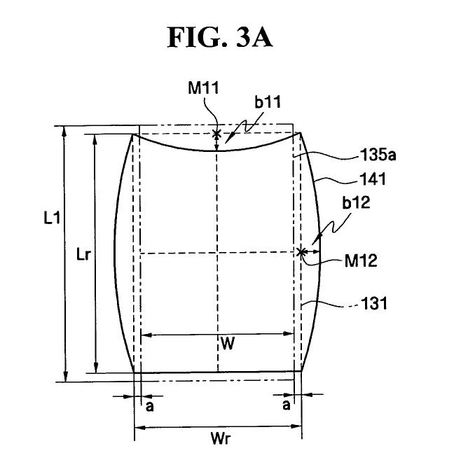

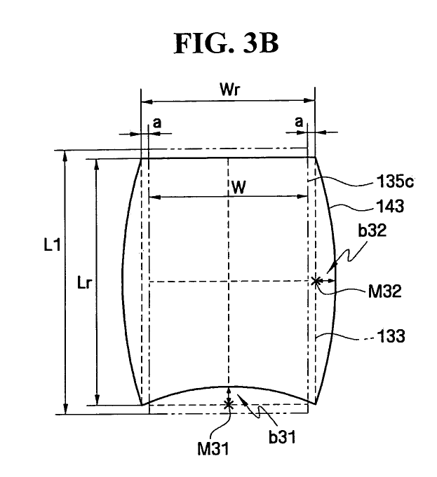

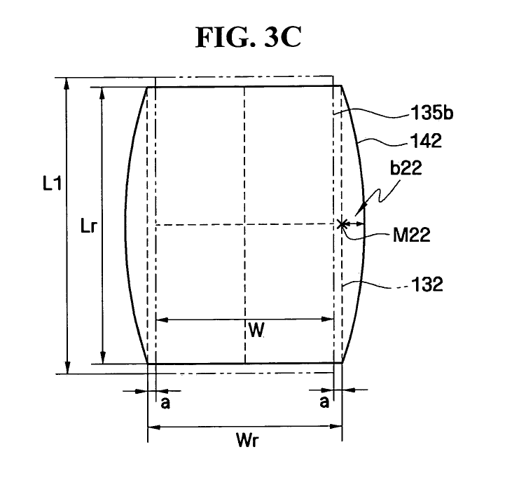

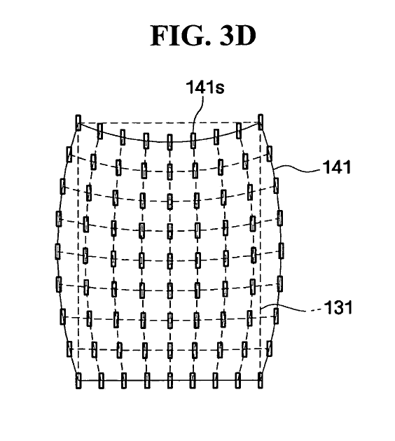

Hereinafter, a deposition mask according to an exemplary embodiment of the present invention will be described with reference to FIGS. 1 through 4. FIG. 1 is a perspective view of a deposition mask 120 according to an exemplary embodiment of the present invention. FIG. 2 is a plan view of the deposition mask 120 shown in FIG. 1. FIGS. 3A through 3C are conceptual views for explaining a method of obtaining first through n^{th} corrected patterns 141 through 143 from first through n^{th} initially designed patterns 131 through 133 shown in FIG. 2.

Referring to FIGS. 1 through 3C, the deposition mask 120 according to the current exemplary embodiment is placed on a mask frame 100. The deposition mask 120 includes the first through n^{th} corrected patterns 141 through 143 obtained by correcting the first through n^{th} initially designed patterns 131 through 133.

The first through n^{th} initially designed patterns 131 through 133 may be sequentially arranged in a first direction and may be corrected in a row direction and a column direction to define the first through n^{th} corrected patterns 141 through 143.

Referring to FIG. 1, the deposition mask 120 may be placed on the mask frame 100 by a tensile force. Accordingly, the first through n^{th} initially designed patterns 131 through 133 may be corrected in the row direction and the column direction in view of the tensile force. The deposition mask 120 placed on the mask frame 100 may include the first through n^{th} corrected patterns 141 through 143 obtained by correcting the first through n^{th} initially designed patterns 131 through 133, which are sequentially arranged in the first direction, in the row and column directions in view of the tensile force.

Each of the first through n^{th} initially designed patterns 131 through 133 and each of the first through n^{th} corrected patterns 141 through 143 may correspond to one display panel. For example, the first corrected pattern 141 obtained by correcting the first initially designed pattern 131 may correspond to a first display panel. Similarly, the n^{th} corrected pattern 143 obtained by correcting the n^{th} initially designed pattern 133 may correspond to an n^{th} display panel.

As shown in the drawings, the first through n^{th} initially designed patterns 131 through 133 and the first through n^{th} corrected patterns 141 through 143 may be defined to correspond to three display panels in the first direction. The three initially designed patterns 131 through 133 and the three corrected patterns 141 through 143 may be arranged in a row on the deposition mask 120. The number of patterns may vary according to the purpose of using the deposition mask 120. The number of patterns is not limited to three as shown in the drawing. One or two patterns or three or more patterns can be provided.

The deposition mask 120 may be thin and may include fine patterns. An optimal tensile force may be applied to the deposition mask 120 to bond the deposition mask 120 onto the mask frame 100. Here, it is desirable to place the patterns with precision. Therefore, the deposition mask 120 placed on the mask frame 100 may include first through n^{th} device patterns 135a through 135c (collectively indicated by reference numeral 135 in FIG. 1) as shown in FIGS. 3A through 3B. The first through n^{th} device patterns 135a through 135c may be formed by bonding the deposition mask 120 having the first through n^{th} corrected patterns 141 through 143 onto the mask frame 100 with the tensile force. Thus, the deposition mask 120 can be placed on the mask frame 100 without a reduction in the precision of its patterns.

The first through n^{th} corrected patterns 141 through 143 obtained by correcting the first through n^{th} initially designed patterns 131 through 133 in the row direction and the column direction may be defined on the deposition mask 120, and this deposition mask 120 may be bonded onto the mask frame 100 with a tensile force, thereby forming the first through n^{th} device patterns 135a through 135c. Although not shown in FIG. 1, each of the first through n^{th} corrected patterns 141 through 143 may include a plurality of apertures, such as, for example, slits. A method of defining the first through n^{th} corrected patterns 141 through 143 and the arrangement of slits in each of the first through n^{th} corrected patterns 141 through 143 will be described later with reference to FIGS. 3A through 3D.

Referring to FIG. 2, the first through n^{th} initially designed patterns 131 through 133 may be arranged sequentially along the first direction. As shown in the drawing, the first through n^{th} initially designed patterns 131 through 133 may be arranged in a row, and the tensile force may be applied in a direction in which the first through n^{th} initially designed patterns 131 through 133 are arranged, for example, in the first direction. The tensile force may be applied toward opposing sides with respect to the direction in which the first through n^{th} initially designed patterns 131 through 133 are arranged in a row. The tensile force may be applied in a direction from the middle of the first through n^{th} initially designed patterns 131 through 133 as a whole toward respective sides of the first initially designed pattern 131 and the n^{th} initially designed pattern 133. Herein, the term “first direction” may denote the direction in which the first through n^{th} initially designed patterns 131 through 133, the first through n^{th} corrected patterns 141 through 143, and the first through n^{th} device patterns 135a through 135c are arranged. In addition, the term “first direction” may denote one of the opposing directions in which the tensile force is applied.

The first through n^{th} corrected patterns 141 through 143 are obtained by correcting the first through n^{th} initially designed patterns 131 through 133 in the row direction and the column direction in view of the tensile force. Outermost sides of the first through n^{th} corrected patterns 141 through 143 may include first outermost sides, extending in a second direction perpendicular to the first direction, and second outermost sides, extending in a direction parallel to the first direction. More specifically, the outermost sides of the first through n^{th} corrected patterns 141 through 143 may be sides at outermost edges of the first through n^{th} corrected patterns 141 through 143 arranged sequentially. Here, the term “extending in the second direction” may denote extending in a direction perpendicular to the first direction, that is, perpendicular to the direction in which the first through n^{th} initially designed patterns 131 through 133 are arranged or perpendicular to the direction in which the tensile force is applied.

Referring to FIG. 2, an upper side of the first initially designed pattern 131, a lower side of the n^{th} initially designed pattern 133, and left and right sides of the first through n^{th} initially designed patterns 131 through 133 may be defined as outermost sides of the first through n^{th} initially designed patterns 131 through 133 arranged sequentially. (The terms “upper,” “lower,” “left,” “right,” and “lateral” may refer to the orientation of sides with reference to upper, lower, left and right areas of the drawing sheet). As described above, the first through n^{th} corrected patterns 141 through 143 are obtained by correcting the first through n^{th} initially designed patterns 131 through 133. Thus, sides of the first through n^{th} corrected patterns 141 through 143 which correspond respectively to the outermost sides of the first through n^{th} initially designed patterns 131 through 133 may be defined as the outermost sides of the first through n^{th} corrected patterns 141 through 143. For example, an upper side of the first corrected pattern 141 shown in FIG. 3A, a lower side of the n^{th} corrected pattern 143 shown in FIG. 3B, and both sides of the first through n^{th} corrected patterns 141 through 143 shown in FIGS. 3A through 3C may be defined as the outermost sides of the first through n^{th} corrected patterns 141 through 143.

Further, the first outermost sides of the first through n^{th} corrected patterns 141 through 143 are sides extending in the second direction perpendicular to the first direction (i.e., a pattern arrangement direction), that is, the upper side of the first corrected pattern 141 and the lower side of the n^{th} corrected pattern 143. The first outermost sides have a first curvature and are recessed inwardly with respect to the first and n^{th} initially designed patterns 131 and 133. The second outermost sides of the first through n^{th} corrected patterns 141 through 143 are the two sides of the first through n^{th} corrected patterns 141 through 143 that extend along the pattern arrangement direction. The second outermost sides have a second curvature and protrude outwardly with respect to the first through n^{th} initially designed patterns 131 through 133.

Referring to FIG. 3A, the first curvature may be determined by first and second points at two opposite ends of a first side (corresponding to one of the first outermost sides) of the first initially designed pattern 131 and a third point separated from a first midpoint M11 of the first side by a first distance b11 in a direction opposite to the direction in which the tensile force is applied. For example, the first curvature may be determined by a circumscribed circle of a triangle defined by the first through third points. More specifically, the first corrected pattern 141 may have a first side included in the first outermost sides, second and third sides included in the second outermost sides, and a fourth side facing the second corrected pattern 142. In this case, the first side may be the upper side of the first corrected pattern 141, the second and third sides may be opposite lateral sides of the first corrected pattern 141, and the fourth side may be a lower side of the first corrected pattern 141, as shown in FIG. 3A.

Referring to FIG. 3A, among the first through n^{th} device patterns 135a through 135c placed on the mask frame 100 by the tensile force, the first device pattern 135a may have a first length L1 defined by the first direction and a first width W defined by the second direction. In addition, the first initially designed pattern 131 may correspond to the first device pattern 135a and may have a second length Lr defined by the first direction and a second width Wr defined by the second direction. In this case, the second length Lr may be smaller than the first length L1, and the second width Wr may be greater than the first width W. For example, the second length Lr of the first initially designed pattern 131 may be approximately 99.97% of the first length L1 of the first device pattern 135a. In addition, the second width Wr of the first initially designed pattern 131 may be greater than the first width W of the first device pattern 135a by a distance “a” on both lateral sides of the first device pattern 135a. The value of “a” may be, e.g., 1 μm. In this case, the second width Wr may be 2 μm greater than the first width W.

In other words, in view of the tensile force to be applied to the deposition mask 120, the first length L1 of the first device pattern 135a may be reduced to a predetermined percentage thereof, and the first width W of the first device pattern 135a may be increased by a predetermined amount. The above values of the length reduction percentage and the amount of increase in width are merely examples and may vary according to the magnitude of the tensile force applied to the deposition mask 120. That is, a ratio of the second length Lr to the first length L1 and the amount of increase from the first width W to the second width Wr may be determined by the magnitude of the tensile force.

The second length Lr and the second width Wr of each of the first through n^{th} initially designed patterns 131 through 133 may be identified in all of the first through n^{th} device patterns 135a through 135c. That is, each of the first through n^{th} device patterns 135a through 135c may have the first length L1, and each of the first through n^{th} initially designed patterns 131 through 133 may have the second length Lr. In this case, the second length Lr may be smaller than the first length L1. In some other embodiments, a different length reduction percentage may be applied to each of the first through n^{th} device patterns 135a through 135c in view of the magnitude of the tensile force applied to each of the first through n^{th} initially designed patterns 131 through 133. That is, different length reduction percentages may be applied to the first device pattern 135a and the second device pattern 135b to define the first initially designed pattern 131 and the second initially designed pattern 132.

Further, the first device pattern 135a has the first width W defined by the second direction, and the first initially designed pattern 131 has the second width Wr. In this case, the second width Wr may be greater than the first width W. For example, the second width Wr of the first initially designed pattern 131 may be achieved by increasing the first width W of the first device pattern 135a by 1 μm on each of the opposing lateral sides of the first device pattern 135a. In other words, since the pattern width can be reduced when the tensile force is applied to the deposition mask 120 along the first direction, the width W of the first device pattern 135a is increased by a predetermined amount. However, the above amount of increase in width is merely an example and may vary according to the magnitude of the tensile force applied to the deposition mask 120. That is, the amount (e.g., percentage) of increase from the first width W to the second width Wr may be determined by the magnitude of the tensile force.

The second width Wr of each of the first through n^{th} initially designed patterns 131 through 133 may be identified in all of the first through n^{th} device patterns 135a through 135c. That is, each of the first through n^{th} device patterns 135a through 135c may have the first width W, and each of the first through n^{th} initially designed patterns 131 through 133 may have the second width Wr. In this case, the second width Wr may be greater than the first width W. In some other embodiments, different amounts of increase in width may be applied to the first through n^{th} device patterns 135a through 135c. That is, different amounts of increase in width may be applied to the first device pattern 135a and the second device pattern 135b to define the first initially designed pattern 131 and the second initially designed pattern 132.

Each of the first width W and the second width Wr may refer to a length of a side of each of the first through n^{th} device patterns 135a through 135c which faces an adjacent device pattern or a side of each of the first through n^{th} initially designed patterns 131 through 133 which faces an adjacent initially designed pattern. For example, the first width W of the first device pattern 135a may be a width of a side (i.e., a lower side) of the first device pattern 135a which faces the adjacent second device pattern 135b, and the second width Wr of the first initially designed pattern 131 may be a width of a side (i.e., a lower side) of the first initially designed pattern 131 which faces the adjacent second initially designed pattern 132.

The second outermost sides have the second curvature and protrude outwardly with respect to the first through n^{th} initially designed patterns 131 through 133. The second curvature may be determined by fourth and fifth points at both ends of a second side (corresponding to each of the second outermost sides) of each of the first through n^{th} initially designed patterns 131 through 133 and a sixth point separated from a second midpoint M12 of the second side by a second distance b12 in a direction perpendicular to the direction in which the tensile force is applied. As shown in FIG. 3A, the second outermost sides may be respective lateral sides of the first corrected pattern 141 which protrude outwardly with respect to corresponding sides of the first initially designed pattern 131.

Referring to FIG. 3B, the n^{th} corrected pattern 143 may be defined in a similar way to the way that the first correction pattern 141 (see FIG. 3A) is defined. Specifically, the n^{th} corrected pattern 143 may have a first side included in the first outermost sides, second and third sides included in the second outermost sides, and a fourth side facing the (n−1)^{th} corrected pattern 142, as shown in FIG. 3B.

More specifically, the first side (included in the first outermost sides) of the n^{th} corrected pattern 143 may be a side (i.e., the lower side) extending in the second direction perpendicular to the first direction (i.e., the pattern arrangement direction). The first side of the n^{th} corrected pattern 143 may have the first curvature and may be recessed inwardly with respect to the n^{th} initially designed pattern 133. In addition, the second and third sides (included in the second outermost sides) of the n^{th} corrected pattern 143 may be lateral sides of the n^{th} corrected pattern 143 which extend along the pattern arrangement direction. The second and third sides of the n^{th} corrected pattern 143 may have the second curvature and may protrude outwardly with respect to the n^{th} initially designed pattern 133.

As shown in the drawing, the first curvature may be determined by first and second points at opposite ends of a first side (i.e., the lower side) of the n^{th} initially designed pattern 133 and a third point separated from a first midpoint M31 of the first side by a first distance b31 in a direction opposite to the direction in which the tensile force is applied. More specifically, the first curvature may be defined by a curve that passes through a point located the first distance b31 into the n^{th} initially designed pattern 133 from the midpoint M31 of the lower side of the n^{th} initially designed pattern 133. If the deposition mask 120 is placed on the mask frame 100 by the tensile force, the n^{th} device pattern 135c may have the first length L1 defined by the first direction and the first width W1 defined by the second direction. Like the first corrected pattern 141, the n^{th} corrected pattern 143 corresponding to the n^{th} device pattern 135c may be defined on the deposition mask 120 in view of the tensile force. The method of correcting the first length L 1 and the first width W to the second length Lr and the second width Wr is substantially the same as the method used for the first corrected pattern 141, and thus a detailed description thereof will not be repeated.

Referring to FIG. 3C, each of the second through (n−1)^{th} corrected patterns 142 may have second and third sides included in the second outermost sides, a first side facing a previous corrected pattern, and a fourth side facing a next corrected pattern. In FIGS. 2 through 3C, n is three. Thus, the second through (n−1)^{th} corrected patterns 142 can be described as one second corrected pattern 142. In other words, the second and third sides (included in the second outermost sides) of the second corrected pattern 142 are both sides of the second corrected pattern 142, the first side of the second corrected pattern 142 is an upper side facing the first corrected pattern 141, and the fourth side of the second corrected pattern 142 is a lower side facing the third corrected pattern 143.

The upper and lower sides of the second corrected pattern 142 may be the same as those of the second initially designed pattern 132, as shown in FIG. 3C. However, each of the opposing lateral sides of the second corrected pattern 142 may be determined by fourth and fifth points at opposite ends of a corresponding one of the opposing lateral sides of the second initially designed pattern 132 and a sixth point separated from a midpoint M22 of the corresponding one of the lateral sides by a predetermined distance b22 in a direction perpendicular to the direction in which the tensile force is applied. In other words, each of the lateral sides of the second corrected pattern 142 may be determined by an arc of a circumscribed circle of a triangle defined by the fourth through sixth points.

The second corrected pattern 142 also has the second length Lr and the second width Wr obtained by correcting the first length L1 and the first width W of the second device pattern 135b. The correction method may be the same as the above-described correction method.

As described above, a plurality of apertures, e.g., slits may be formed in each of the first through n^{th} corrected patterns 141 through 143.

For example, referring to FIG. 3D, a plurality of slit lines 141s may be arranged in the first corrected pattern 141 to correspond to the outermost sides of the first corrected pattern 141. The slit lines 141s may be arranged to correspond to the outermost sides of the first corrected pattern 141 corrected from the first initially designed pattern 131.

That is, a first slit line corresponding to the first outermost side (i.e., the upper side) of the first corrected pattern 141 may have the first curvature and may be arranged along the first outermost side recessed inwardly with respect to the first initially designed pattern 131. An n^{th} slit line corresponding to the lower side (i.e., the fourth side) of the first corrected pattern 141 may be arranged along the lower side of the first corrected pattern 141. When the lower side of the first corrected pattern 141 has a length obtained by increasing the length of the first initially designed pattern 131 in a widthwise direction as described above, slits of the n^{th} slit line may be arranged to correspond to the increased length.

The curvature of the slit lines 141s may be gradually reduced from top to bottom as shown in the drawing. In other words, the curvature of the first slit line disposed at the top of the first corrected pattern 141 may be greater than that of a second slit line disposed under the first slit line, and the curvature of the n^{th} slit line corresponding to the lower side of the first corrected pattern 141 may be smaller than that of an (n−1)^{th} slit line disposed above the n^{th} slit line. For example, the curvature of the n^{th} slit line may be zero.

In the drawing, the slit lines 141s corresponding to the first corrected pattern 141 are illustrated. However, the same slit lines 141s can also be applied to the second through n^{th} corrected patterns 142 and 143. For example, the curvature of slit lines in the n^{th} corrected pattern 143 may gradually increase from bottom to top, as shown in FIG. 3B. In other words, the curvature of a first slit line at the top of the n^{th} corrected pattern 143 may be smaller than that of a second slit line disposed under the first slit line. Here, the curvature of the first slit line may be, e.g., zero. Further, the curvature of an n^{th} slit line may be greater than that of an (n−1)^{th} slit line disposed above the n^{th} slit line. For example, the n^{th} slit line may have the first curvature of the lower side of the n^{th} corrected pattern 143.

Herein, the phrase that “a slit line has a curvature” may refer to a configuration in which slits connected by a virtual line form a curve having a certain curvature. As shown in the drawing, the slit lines 141s may be arranged to have a curvature not only in the row direction but also in the column direction. The curvature in the column direction may be determined by the curvature of the lateral sides (i.e., the second outermost sides) of each of the first through n^{th} corrected patterns 141 through 143.

In the deposition mask 120 according to the current exemplary embodiment, initially designed patterns and corrected patterns are defined in view of a tensile force applied to the deposition mask 120 to fix the deposition mask 120 onto the mask frame 100. Therefore, the precision of the patterns can be maintained.

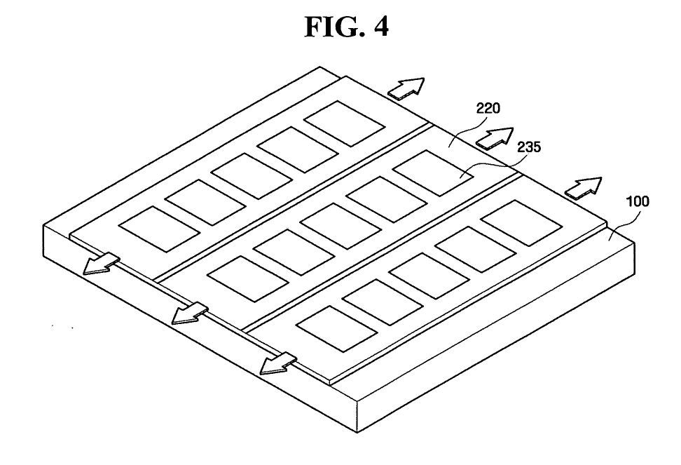

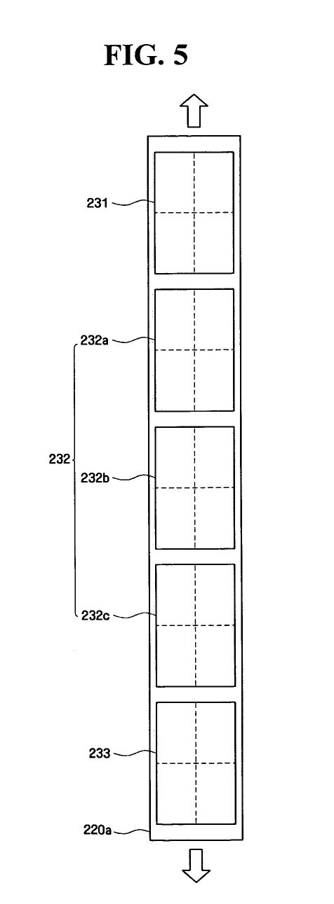

Hereinafter, a deposition mask according to another exemplary embodiment of the present invention will be described with reference to FIGS. 4 and 5. FIG. 4 is a perspective view of a deposition mask according to another exemplary embodiment of the present invention. FIG. 5 is a cross-sectional view of the deposition mask shown in FIG. 4.

Referring to FIGS. 4 and 5, the deposition mask according to the current exemplary embodiment is placed on a mask frame. The deposition mask includes first through n^{th} corrected patterns obtained by correcting first through n^{th} initially designed patterns 231 through 233. Since the deposition mask is placed on the mask frame by a tensile force, the first through n^{th} corrected patterns may be defined on the deposition mask in view of the tensile force.

More specifically, the first through n^{th} initially designed patterns 231 through 233 may be arranged sequentially in a first direction, and the first through n^{th} corrected patterns may be defined by correcting the first through n^{th} initially designed patterns 231 through 233 in a row direction and a column direction in view of the tensile force. Outermost sides of the first through n^{th} corrected patterns may include first outermost sides extending in a second direction perpendicular to the first direction and second outermost sides extending in a direction parallel to the first direction. The first outermost sides have a first curvature and are recessed inwardly with respect to the first through n^{th} initially designed patterns 231 through 233, and the second outermost sides have a second curvature and protrude outwardly with respect to the first through n^{th} initially designed patterns 231 through 233.

The deposition mask according to the current exemplary embodiment is different from the deposition mask 120 according to the previous exemplary embodiment in that the deposition mask according to the current exemplary embodiment includes five device patterns. In other words, n is five. The first outermost sides may be recessed inwardly with respect to the deposition mask from an upper side of the first initially designed pattern 231 and a lower side of the fifth initially designed pattern 233, and the second outermost sides may protrude outwardly with respect to the deposition mask from both sides of the first through fifth initially designed patterns 231, 232a, 232b, 232c and 233.

That is, the first initially designed pattern 231 according to the current exemplary embodiment may be corrected in the same way as the first initially designed pattern 131 (see FIG. 3A) according to the previous exemplary embodiment is corrected inwardly with respect to the first corrected pattern 141, and the n^{th} initially designed pattern, i.e., the fifth initially designed pattern 233 according to the current exemplary embodiment may be corrected in the same way as the third initially designed pattern 133 (see FIG. 3B) according to the previous exemplary embodiment is corrected inwardly with respect to the third corrected pattern 143. Similarly, the second through fourth initially designed patterns 232a through 232c according to the current exemplary embodiment may be corrected in the same way as the second initially designed pattern 132 (see FIG. 3C) according to the previous exemplary embodiment is corrected inwardly with respect to the second corrected pattern 143. Since the correction method has been described above, a detailed description thereof will not be repeated.

By way of summary and review, an organic electroluminescent device may include a first electrode formed in a predetermined pattern on an insulating substrate, an organic film formed on the substrate having the first electrode by vacuum deposition, and a second electrode formed on the organic film in a direction intersecting the first electrode. Since the organic film may be susceptible to moisture, it may be difficult to perform an etching process using a photolithography process after the organic film is formed during the manufacture of the organic electroluminescent device. Accordingly, the organic light-emitting material of the organic film and the material of the second electrode may be deposited in a vacuum state using a mask having certain patterns.

When a deposition mask is used, the deposition mask may be placed on a frame such that a tensile force is applied to the deposition mask. However, when the tensile force is applied to the deposition mask, it may be difficult to maintain the precision of the patterns formed on the deposition mask.

The present embodiments provide a deposition mask whose pattern precision can be maintained even when a tensile force is applied thereto. More specifically, in the deposition mask according to the current exemplary embodiments, initially designed patterns and corrected patterns are defined in view of a tensile force applied to the deposition mask to fix the deposition mask onto the mask frame. Therefore, the precision of the patterns can be maintained.

What is claimed is:

1. A deposition mask placed on a mask frame by a tensile force, the deposition mask comprising first through n^{th} corrected patterns obtained by correcting first through n^{th} initially designed patterns, that include a first initially designed pattern and an n^{th} initially designed pattern, the first through n^{th} initially designed patterns being arranged sequentially in a first direction, in a row direction and a column direction in view of the tensile force applied to the deposition mask, wherein outermost sides of the first through n^{th} corrected patterns include first outermost sides extending in a second direction perpendicular to the first direction and second outermost sides extending in a direction parallel to the first direction, wherein the first outermost sides have a first curvature and are recessed inwardly with respect to the first and the n^{th} initially designed patterns, and the second outermost sides have a second curvature and protrude outwardly with respect to the first through n^{th} initially designed patterns.

2. The deposition mask of claim 1, wherein the first curvature is determined by first and second points at opposite ends of a first side of each of the first and the n^{th} initially designed patterns which corresponds to each of the first outermost sides and a third point separated from a first midpoint of the first side by a first distance in a direction opposite to a direction in which the tensile force is applied.

3. The deposition mask of claim 2, wherein the second curvature is determined by fourth and fifth points at opposite ends of a second side of each of the first through n^{th} initially designed patterns which corresponds to each of the second outermost sides and a sixth point separated from a second midpoint of the second side by a second distance in a direction perpendicular to the direction in which the tensile force is applied.

4. The deposition mask of claim 1, wherein each of the first through n^{th} corrected patterns includes a plurality of slit lines.

5. The deposition mask of claim 4, wherein the slit lines are arranged in each of the first through n^{th} corrected patterns in view of the tensile force.

6. The deposition mask of claim 1, further comprising first through n^{th} device patterns placed on the mask frame by the tensile force, wherein each of the first through n^{th} device patterns has a first length defined by the first direction and a first width defined by the second direction, and the first through n^{th} initially designed patterns correspond respectively to the first through n^{th} device patterns and have a second length defined by the first direction and a second width defined by the second direction, wherein the second length is smaller than the first length, and the second width is greater than the first width.

7. The deposition mask of claim 6, wherein a ratio of the second length to the first length and a ratio of the second width relative to the first width are determined by a magnitude of the tensile force.

8. The deposition mask of claim 1, wherein the first through n^{th} corrected patterns include a second corrected pattern and an (n−1)^{th} corrected pattern, and wherein each of the first through n^{th} corrected patterns and each of the first through n^{th} initially designed patterns includes at least four sides, wherein the first corrected pattern includes a first side included in the first outermost sides, second and third sides included in the second outermost sides and a fourth side facing the second corrected pattern, the n^{th} corrected pattern includes a first side included in the first outermost sides, second and third sides included in the second outermost sides and a fourth side facing the (n−1)^{th} corrected pattern, and each of the second through (n−1)^{th} corrected patterns includes second and third sides included in the second outermost sides, a first side facing a previous corrected pattern and a fourth side facing a next corrected pattern.

9. The deposition mask of claim 8, wherein the first sides of the first corrected pattern and the n^{th} corrected pattern are recessed inwardly with respect to the first and the n^{th} initially designed patterns, and the second and third sides of the first through n^{th} corrected patterns protrude outwardly with respect to the first through n^{th} initially designed patterns.

10. The deposition mask of claim 1, wherein each of the first through n^{th} initially designed patterns corresponds to any one of a plurality of display panels placed on the mask frame.

11. The deposition mask of claim 1, wherein each of the first through n^{th} initially designed patterns includes a plurality of apertures.

12. A deposition mask placed on a mask frame by a tensile force, the deposition mask comprising first through n^{th} corrected patterns which correspond respectively to a plurality of display panels arranged in a row along a first direction parallel to a direction of the tensile force applied to the deposition mask, wherein outermost sides of the first through n^{th} corrected patterns include first outermost sides extending in a second direction perpendicular to the first direction and second outermost sides extending in a direction parallel to the first direction, wherein the first outermost sides have a first curvature and are recessed inwardly with respect to first and the n^{th} initially designed patterns, and the second outermost sides have a second curvature and protrude outwardly with respect to first through n^{th} initially designed patterns.

13. The deposition mask of claim 12, further comprising first through n^{th} device patterns placed on the mask frame by the tensile force and the first through n^{th} initially designed patterns corresponding respectively to the first through n^{th} device patterns, wherein each of the first through n^{th} device patterns has a first length defined by the first direction, and each of the first through n^{th} initially designed patterns has a second length defined by the first direction, wherein the second length is smaller than the first length.

14. The deposition mask of claim 13, wherein each of the first through n^{th} initially designed patterns has a first width defined by the second direction perpendicular to the first direction, and each of the first through n^{th} corrected patterns has a second width defined by the second direction, wherein the second width is greater than the first width.

15. The deposition mask of claim 13, wherein the first curvature is determined by first and second points at opposite ends of a first side of each of the first and the n^{th} initially designed patterns which corresponds to each of the first outermost sides and a third point separated from a first midpoint of the first side by a first distance in a direction opposite to the direction in which the tensile force is applied.

16. The deposition mask of claim 15, wherein the second curvature is determined by fourth and fifth points at opposite ends of a second side of each of the first through n^{th} initially designed patterns which corresponds to each of the second outermost sides and a sixth point separated from a second midpoint of the second side by a second distance in a direction perpendicular to the direction in which the tensile force is applied.
